(19) United States
(12) Patent Application Publication
(10) Pub. No.: US 2001/0033947 A1
(43) Pub. Date: Oct. 25, 2001

(54) Magnetic recording medium

(75) Inventor: Futoshi Sasaki, Miyagi (JP)

Correspondence Address: SONNENSCHEIN NATH & ROSENTHAL, P.O. BOX 061080, WACKER DRIVE STATION, CHICAGO, IL, 60606-1080, US

(73) Assignee: Sony Corporation

(21) Appl. No.: 09/808,528

(22) Filed: Mar. 14, 2001

(30) Foreign Application Priority Data
Mar. 15, 2000 (JP) P2000-077852

(51) Int. Cl. G11B 5/70

(52) U.S. Cl. 428/694 BR

(57) ABSTRACT

When it is assumed that A is an area value of an absorption spectrum of a wavelength 2940 cm⁻¹ to 2800 cm⁻¹ when the magnetic layer surface is measured by the attenuated total reflectance measurement method using the Fourier transform infrared spectroscopy and B is an area value of an absorption spectrum of a wavelength 2940 cm⁻¹ to 2800 cm⁻¹ when the magnetic layer surface without the lubricant layer is measured by the attenuated total reflectance measurement method using the Fourier transform infrared spectroscopy, a value (A−B) is in a range not less than 0.01 and not greater than 0.30. This enables to accurately evaluate a lubricant amount on the magnetic layer surface and to simultaneously obtain an excellent running durability and an excellent electro-magnetic conversion characteristic.

### BACKGROUND OF THE INVENTION

1. Field of the Invention

The present invention relates to a magnetic recording medium including a lubricant layer formed on a magnetic layer formed by applying a magnetic paint.

2. Description of the Prior Art

A magnetic disc is a magnetic recording medium which is used for a computer or a word processor and can easily be carried. As a conventionally used magnetic disc, a floppy disc called “2HD” (trade name) is available. This 2HD floppy disc has a recording capacity of 1.44 MB (megabytes). Such a magnetic disc includes a magnetic layer formed on a non-magnetic support body by applying a magnetic paint prepared by kneading a magnetic powder and a binder. Such a magnetic disc has a sufficient recording capacity for recording characters data but its capacity is not sufficient for recording information of a large file size such as a sound data and an image data. Furthermore, with sophistication of application soft, the magnetic disc is expected to have a sufficient recording capacity, i.e., a higher capacity.

In order to realize a high capacity of the magnetic disc, it is necessary to use a signal of a short wavelength range. For this, when the magnetic disc has a high capacity, it becomes necessary to improve output of a signal of a short wavelength range. In order to answer to these requirements, it is considered to make the magnetic layer of the magnetic disc thinner. When the magnetic layer has a smaller thickness in the magnetic disc, it is possible to reduce the self demagnetization loss during recording and the thickness loss during reproducing, which in turn enables to record/reproduce a signal of the short wavelength range.

However, when the magnetic layer is to be made with a thickness not greater than, for example, 0.5 μm, it is difficult to obtain a uniform film or to realize an excellent productivity. That is, when the magnetic layer has a reduced thickness, the surface of the magnetic layer is affected by the surface characteristic of the non-magnetic support body and has protrusions and indentations, which deteriorates the spacing loss and the electro-magnetic conversion characteristic and increases drop-out.

For this, there has been suggested a magnetic disc having a lower non-magnetic layer formed by applying onto the non-magnetic support body a magnetic paint prepared by dispersing a non-magnetic powder in a binder and an upper magnetic layer formed by applying thereon a magnetic paint prepared by dispersing a ferromagnetic metal powder in a binder. In this magnetic disc, the lower non-magnetic layer is arranged between the upper magnetic layer and the non-magnetic support body so that the upper magnetic layer can have a surface not affected by the surface characteristic of the non-magnetic support body. Accordingly, in this magnetic disc, the surface characteristic of the upper magnetic layer is improved, which in turn reduces the spacing loss, enabling to obtain an excellent electro-magnetic conversion characteristic.

On the other hand, in the magnetic disc, it is also desired to increase the data transfer rate. When the recording capacity is increased, lowering of the data transfer rate causes deterioration of workability. Increase of the data transfer rate can be realized, for example by increasing the rpm for driving the magnetic disc. While the magnetic disc is rotating at a high speed, recording/reproducing is performed by a flying type magnetic head flying at several tens to hundreds nm from the surface of the magnetic layer.

When recording/reproducing is performed by the flying type magnetic head while the magnetic disc is rotating at a high speed, the magnetic head may collide into the magnetic disc surface and damages the magnetic disc surface. To cope with this, in the magnetic disc, it is considered to increase the paint strength of the magnetic layer by using abrasive particles in the magnetic layer so as to increase the abrasion force of the magnetic layer or changing the characteristics of the magnetic layer to increase the hardness.

However, when the magnetic layer contains abrasive particles, this deteriorates the magnetic characteristic of the magnetic layer and lowers the electro-magnetic conversion characteristic. The abrasion force of the magnetic layer surface may reduce the service life of the flying type magnetic head. Moreover, when controlling the type of the binder or mixture ratio to change the paint characteristic of the magnetic layer, it is impossible to obtain a flat and smooth magnetic layer, thus deteriorating the surface characteristic of the magnetic layer.

To cope with this, conventionally, a lubricant layer is formed on the surface of the magnetic layer so as to improve running stability of the flying type magnetic head, thereby improving the running durability. This lubricant layer is formed by directly painting or spraying a lubricant onto the surface of the magnetic layer, or by adding a lubricant into a magnetic paint, or by immersing the magnetic recording medium itself in a lubricant solution.

However, when this lubricant layer is formed with a great thickness on the magnetic layer surface, a distance between the flying type magnetic head and the magnetic layer is increased, causing a spacing loss. On the contrary, when the lubricant layer is formed with a small thickness on the magnetic layer surface, it becomes impossible to obtain the aforementioned effect to improve the running durability. Moreover, even if the thickness of the lubricant layer is defined, it has been difficult to simultaneously suppress the spacing loss and improve the running durability. In other words, in the conventional magnetic disc, even if the lubricant layer thickness is defined, this cannot define an amount of the lubricant actually existing on the surface has a problem that it is impossible to obtain both of the spacing loss reduction and the running durability improvement.

### SUMMARY OF THE INVENTION

It is therefore an object of the present invention to accurately evaluate a lubricant amount on a magnetic layer surface and provide a magnetic recording medium simultaneously exhibiting an excellent running durability and an excellent electro-magnetic conversion characteristic.

In order to achieve the aforementioned object, the magnetic recording medium according to the present invention includes a non-magnetic support body having a magnetic layer formed by applying a magnetic paint prepared by kneading at least a binder and a magnetic powder and a lubricant layer formed on the magnetic layer surface, wherein a value (A−B) is in a range not less than 0.01 and not greater than 0.30 wherein A is an area value of an absorption spectrum of a wavelength 2940 cm⁻¹ to 2800 cm⁻¹ when the magnetic layer surface is measured by the attenuated total reflectance measurement method using the Fourier transform infrared spectroscopy and B is an area value of an absorption spectrum of a wavelength 2940 cm⁻¹ to 2800 cm⁻¹ when the magnetic layer surface without the lubricant layer is measured by the attenuated total reflectance measurement method using the Fourier transform infrared spectroscopy.

In the magnetic recording medium having the aforementioned configuration, the lubricant amount existing on the magnetic layer is defined as an area value of the absorption spectrum of a wavelength of 2940 cm⁻¹ to 2800 cm⁻¹. Here, the absorption spectrum of the wavelength 2940 cm⁻¹ to 2800 cm⁻¹ measured by the attenuated total reflectance measurement method using the Fourier transform infrared spectroscopy is a spectrum appearing based on the C—H bond contained in the lubricant. Accordingly, in the present invention, unlike the case defining the lubricant amount by the thickness of the lubricant layer or the like, the lubricant amount is defined by the area value of the absorption spectrum in the aforementioned wavelength range, which enables to accurately define the lubricant amount existing on the magnetic layer surface. That is, when the lubricant amount is defined by the lubricant layer thickness or the like, there is a danger that the lubricant amount existing on the magnetic layer surface may not be indicated. As compared to this, in the present invention, it is possible to directly define the lubricant amount existing on the magnetic layer surface after the lubricant layer is formed. Moreover, in the present invention, by defining the value of (A−B) in a range not less than 0.01 and not greater than 0.30, a desired amount of lubricant can exist on the magnetic layer surface.

### BRIEF DESCRIPTION OF THE DRAWINGS

FIG. 1 is a cross sectional view of an essential portion of a magnetic disc as an example of a magnetic recording medium according to the present invention.

FIG. 2 is a chart showing a result of measurement of an upper magnetic layer surface by the attenuated total reflectance measurement method using the Fourier transform infrared spectroscopy.

FIG. 3 schematically shows a paint film formation apparatus for forming a lower non-magnetic layer and an upper magnetic layer by the wet-on-wet coating method.

FIG. 4 schematically shows an example of a coating device of the paint film formation apparatus.

FIG. 5 schematically shows another example of the coating device.

FIG. 6 schematically shows still another example of the coating device.

### DETAILED DESCRIPTION OF PREFERRED EMBODIMENTS

Description will now be directed to specific embodiments of the magnetic recording medium according to the present invention with reference to the attached drawings.

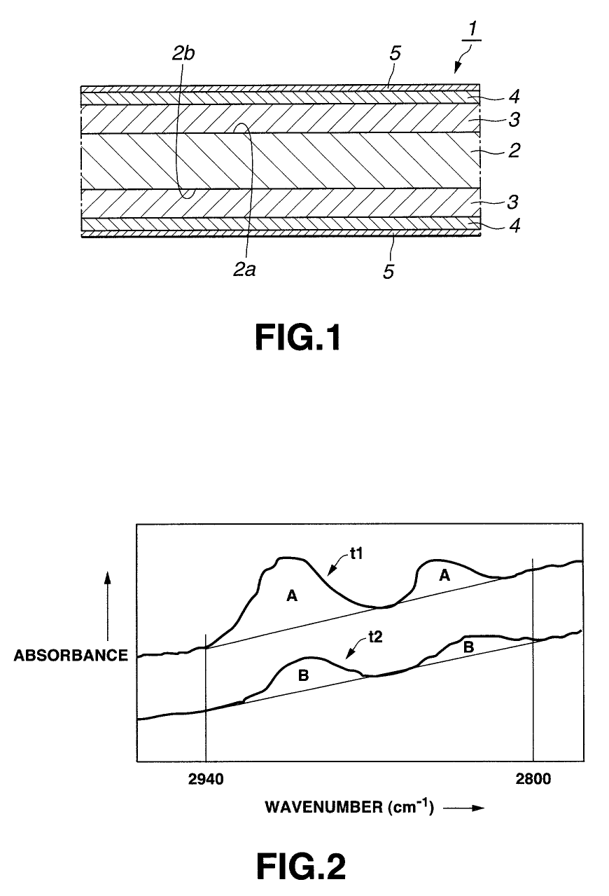

Here, explanation will be given on a disc-shaped magnetic disc 1 shown in FIG. 1 as the magnetic recording medium according to the present invention. This magnetic disc 1 includes a lower non-magnetic layer 3 and an upper magnetic layer 4 successively formed in this order on both surfaces 2a and 2b of a non-magnetic support body 2. Moreover, in this magnetic disc, a lubricant layer 5 is formed on the upper magnetic layer 4. It should be noted that the present invention is not to be limited to a magnetic recording medium having a configuration as the magnetic disc 1. For example, the configuration may be such that the lower non-magnetic layer 3 and the upper magnetic layer 4 are arranged only one of the surfaces 2a of the non-magnetic support body 2, and the lower non-magnetic layer 3 may be replaced by a lower magnetic layer.

In this magnetic disc 1, when it is assumed that A is an area value of an absorption spectrum of a wavelength 2940 cm⁻¹ to 2800 cm⁻¹ when the surface of the upper magnetic layer 4 is measured by the attenuated total reflectance measurement method using the Fourier transform infrared spectroscopy and B is an area value of an absorption spectrum of a wavelength 2940 cm⁻¹ to 2800 cm⁻¹ when the surface of the upper magnetic layer 4 without the lubricant layer 5 is measured by the attenuated total reflectance measurement method using the Fourier transform infrared spectroscopy, the value (A−B) is in a range not smaller than 0.01 and not greater than 0.30. Here, the lubricant layer 5 can be removed, for example, by washing the magnetic disc 1 using an organic solvent such as hexane. However, any method can be used to remove the lubricant layer 5 from the upper magnetic layer 4.

More specifically, as shown in FIG. 2, chart t1 is obtained when the surface of the upper magnetic layer 4 is measured by the attenuated total reflectance measurement method using the Fourier transform infrared spectroscopy, and chart t2 is obtained when the surface of the upper magnetic layer 4 from which the lubricant layer 5 has been removed by washing the surface of the upper magnetic layer 4 using an organic solvent is measured by the attenuated total reflectance measurement method using the Fourier transform infrared spectroscopy. Actually, the base line of t1 is overlaid on the base line of t2 but for simplification, these base lines are shown apart from each other in FIG. 2. When it is assumed that A is an area value of the absorption spectrum appearing at the wavelength of 2940 cm⁻¹ to 2800 cm⁻¹ in chart t1 and B is an area value of the absorption spectrum appearing at the wavelength of 2940 cm⁻¹ to 2800 cm⁻¹ in chart t2, the value (A−B) is not smaller than 0.01 and not greater than 0.30 in this magnetic disc. Moreover, the absorption spectrum of wavelength of 2940 cm⁻¹ to 2800 cm⁻¹ when measurement is performed by the attenuated total reflectance measurement method using the Fourier transform infrared spectroscopy is the spectrum caused by the C—H bond contained in the lubricant.

Here, as the lubricant, it is possible to use conventionally known ones such as silicon oil, fatty acid denatured silicone, fluorine-containing silicone, fluoroester, polyolefin, polyglycol, fatty acid monoester, fatty acid diester, fatty acid triester, fatty acid amide, fatty amine, and olefin oxide. Moreover, each of these lubricants may be used solely or in combination with others. For example, when using as the lubricant a mixture of fatty acid and fatty acid ester, it is preferable to use fatty acid and fatty acid ester with weight ratio of 10:90 to 90:10.

The lubricant layer 5 may be formed by applying a paint prepared by dissolving a lubricant in an organic solvent on a surface of the upper magnetic layer 4 after its formation. Alternatively, a lubricant contained in the upper magnetic layer 4 may be oozed onto the surface of the upper magnetic layer 4 as will be detailed later.

On the other hand, the non-magnetic support body 2 may be made from materials such as polyethylene terephthalate, polyethylene naphthalate, and other polyesters, polypropylene and other polyolefin, cellulose triacetate, cellulose diacetate, and other cellulose derivatives, polyvinyl chloride and other vinyl resins, polycarbonate, polyamide, polysulfone and other plastic as well as aluminum, copper, other metals, glass and other ceramics. These materials of the non-magnetic support body 2 may be applied after performing corona discharge processing, plasma processing, undercoat processing, thermal processing, cleaning processing, metal deposition processing, or alkali processing. The non-magnetic support body 2 preferably has a thickness of 30 μm to 10 mm.

Moreover, in this magnetic disc 1, the upper magnetic layer 4 is formed by applying onto the lower non-magnetic layer 3 a magnetic paint prepared by dispersing a ferromagnetic powder in a binder. The upper magnetic layer 4 preferably contains a magnetic powder, preferably, ferromagnetic powder. The ferromagnetic powder is not limited to a particular one. There can be exemplified a ferromagnetic alloy powder, ferromagnetic hexagonal system ferrite powder, ferromagnetic iron oxide particles, ferromagnetic CrO₂, ferromagnetic cobalt ferrite (CoO—Fe₂O₃), cobalt-adhered oxide, iron nitride fine particles, and the like. The ferromagnetic alloy powder may be Fe alloy powder, Co alloy powder, Ni alloy powder as well as Fe—Co, Fe—Ni, Fe—Co—Ni, Co—Ni, Fe—Co—B, Mn—Bi, Mn—Al, Fe—Co—V and other alloy powders or alloy powder as compounds of these alloys and other elements. Furthermore, in order improve the magnetic characteristic of the ferromagnetic alloy powder, non-metal such as Al, Si, P, B, C and the like may be added. In general, the ferromagnetic alloy power particles have a surface having an oxide layer for chemical stability. The oxide may be formed by known methods such as a method of immersion in an organic solvent followed by drying, a method of immersion in an organic solvent and sending an oxygen-containing gas to form an oxide film on the surface which is dried, a method of forming an oxide film on the surface not using an organic solvent but by adjusting partial pressure of oxygen gas and an inert gas.

The magnetic powders preferably have a specific surface of 20 m²/g to 90 m²/g and more preferably 25 m²/g to 70 m²/g. When the magnetic powder has a specific surface in the aforementioned range, fine particles enable to perform a high-density recording and to obtain an excellent noise characteristic. Moreover, each of these magnetic powders may be used solely or in combination with others.

Furthermore, the binder to be contained in the upper magnetic layer 4 may be conventionally known thermoplastic resin, thermosetting resin, or electronic beam curable resin, or a mixture of these.

The binder as the thermoplastic resin may be, for example, vinyl chloride, vinyl chloride vinyl acetate copolymer, vinyl chloride vinylidene chloride copolymer, vinyl chloride acrylonitrile copolymer, acrylic ester acrylonitrile copolymer, acrylic ester vinylidene chloride copolymer, acrylic ester stylene copolymer, methacrylic acid ester acrylonitrile copolymer, methacrylic acid ester vinylidene chloride copolymer, methacylic acid ester stylene copolymer, urethane elastomer, polyvinyl fluoride, vinylidene chloride acrylonitrile copolymer, butadiene acrylonitrile copolymer, polyamide resin, polyvinyl butyral, cellulose derivative (cellulose acetate butylate, cellulose diacetate, cellulose triacetate, cellulose propionate, nitrocellulose, and the like), stylene butadiene copolymer, polyester resin, various synthetic rubber thermoplastic resin (polybutadiene, polychloroprene, polyisoprene, stylene butadiene copolymer and the like) and mixtures of these. Moreover, the binder as the thermosetting resin may be, for example, phenol resin, epoxy resin, curable polyurethane resin, urea resin, melamine resin, alkyd resin, silicone resin, polyamine resin, urea-formaldehyde resin, and the like.

Moreover, molecules of the resin used as the aforementioned binders may contain a polar functional group such as —SO₃M, —OSO₃M, —PO(OM)₂, —COOM, and the like. Here, in the molecule, M represents hydrogen atom or alkali metal such as lithium, potassium, and sodium. Furthermore, the polar functional group may be hydroxyl group, epoxy group, amino group, or the like. By introducing these polar functional groups into the binder, it is possible to improve dispersion of the magnetic powder. Furthermore, these polar functional groups are preferably contained in the binder with a ratio of 10⁻¹ mol/g to 10⁻⁸ mol/g and more preferably, 10⁻² mol/g to 10⁻⁶ mol/g.

Furthermore, the binder preferably has a glass transition temperature in the range from 50° C. to 70° C. By using a binder having the glass transition temperature in the range from 50° C. to 70° C., the binder can freely flow between the fine magnetic particles and the magnetic powder is preferably dispersed in the binder. Moreover, the binder preferably has an average molecular weight in the range from 5000 to 10000.

Furthermore, the upper magnetic layer 4 may contain an additive such as a non-magnetic reinforcing agent and an antistatic agent which are normally used in a magnetic recording medium.

The non-magnetic reinforcing agent may be, for example, aluminum oxide (α, β, γ), chrome oxide, silicone carbide, diamond, garnet, emery, titanium oxide, α-iron oxide, silicone oxide, silicone nitride, tungsten carbide, molybdenum carbide, boron carbide, corundum, zinc oxide, cerium oxide, magnesium oxide, boron nitride, and the like. The non-magnetic reinforcing agent preferably has an average particle diameter in the range from 0.05 μm to 0.6 μm and more preferably, from 0.05 μm to 0.3 μm. The amount of the non-magnetic reinforcing agent to be added is preferably in a range from 3 weight parts to 20 weight parts with respect to 100 weight parts of the magnetic powder and more preferably, from 5 weight parts to 10 weight parts. Moreover, the non-magnetic reinforcing agent preferably is 4 or above in the Mohs' hardness and more preferably, 5 or above, and further preferably 6 or above. Furthermore, the non-magnetic reinforcing agent preferably has a specific weight in the range from 2 to 6 and more preferably, from 3 to 5.

The antistatic agent may be, for example, cation surface active agent such as quaternary amine; anion surface active agent containing acid radical such as sulfonic acid, sulfuric acid, phosphoric acid, phosphoric acid ester, carbonic acid, and the like; and ampholytic surface active agent such as amino sulfonic acid. These antistatic agents are preferably added in the amount of 0.01 weight % to 40 weight % against the binder. As the antistatic agent, it is also possible to add conductive fine powder. The conductive fine powder may be, for example, carbon black, graphite, tin oxide, silver powder, silver oxide, silver nitrate, organic compound of silver, copper powder and other metal particles, or pigment such as zinc oxide, barium sulfuric acid, titanium oxide, and other metal oxide which are coated by a conductive material such as a tin oxide film or antimony solution tin oxide film. These conductive fine powders preferably have an average particle diameter of 5 nm to 700 nm and more preferably, 5 nm to 200 nm.

Next, explanation will be given on the lower non-magnetic layer 3.

The lower non-magnetic layer 3 contains a non-magnetic powder, The non-magnetic powder may be, for example, α-Fe₂O₃, TiO₂, carbon black, graphite, barium sulfuric acid, ZnS, MgCO₃, CaCO₃, ZnO, CaO, tungsten disulfide, molybdenum disulfide, boron nitrite, MgO, SnO₂, Cr₂O₃, α-Al₂O₃, α-FeOOH, SiC, cerium oxide, corundum, artificial diamond, α-iron oxide, garnet, quartzite, silicon nitride, boron nitride, silicon carbide, molybdenum carbide, boron carbide, tungsten carbide, titanium carbide, tripoli, diatomaceous earth, dolomite, and the like.

Among them, especially preferable is inorganic powder such as α-Fe₂O₃, TiO₂, carbon black, CaCO₃, barium sulfuric acid, α-Al₂O₃, α-FeOOH, Cr₂O₃ and polymer powder such as polyethylene.

Moreover, the binder contained in the lower non-magnetic layer 3 is preferably selected considering the condition to satisfy the surface characteristic of the lower non-magnetic layer 3, i.e., dispersion capability of the pigment contained in the lower non-magnetic layer 3 and the uniformity of the boundary surface between the lower non-magnetic layer 3 and the upper magnetic layer 4. As such binders, similarly as the binder used in the aforementioned upper layer magnetic layer 4, it is possible to use conventional known thermoplastic resin, thermosetting resin, or radiation crosslinked resin by electron beam, or a mixture of these.

Furthermore, the lower non-magnetic layer 3 may be added by an antistatic agent. The antistatic agent may be, for example, conductive fine powder such as carbon black and carbon black graft polymer; a natural surface active agent such as saponin; nonion surface active agent such as alkylene oxide, glycerin, and glycidol; higher alkylamine, quaternary ammonium salt, pyridine, other heterocyclic compound salts, phosphonium, sulfonium, and other cation surface active agents; anion surface active agent containing an acidic group such as carbonic acid, phosphoric acid, sulfuric acid ester group, phosphoric acid ester group; ampholytic surface active agent such as amino acid, aminosulfonic acid, amino alcohol sulfuric acid or phosphoric acid ester, and the like. When using the aforementioned conductive fine powder as the antistatic agent, for example, it is used in the range of 1 weight part to 15 weight parts with respect to 100 weight parts of the non-magnetic powder. When using the aforementioned surface active agents as the antistatic agent, similarly, it is used in the range of 1 weight part to 15 weight parts.

Furthermore, similarly as the upper magnetic layer 4, the lower non-magnetic layer 3 may contain inorganic particles having the Mohs' hardness of 5 or above. As the inorganic particles having the Mohs' hardness of 5 or above, there can be exemplified Al₂O₃ (Mohs' hardness 9), TiO (Mohs' hardness 6), TiO₂ (Mohs' hardness 6.5), SiO₂ (Mohs' hardness 7), SnO₂ (Mohs' hardness 6.5), Cr₂O₃ (Mohs' hardness 9), and α-Fe₂O₃ (Mohs' hardness 5.5). Each of these may be used solely or in combination with others.

It should be noted that the lower non-magnetic layer 3 may contain the aforementioned lubricants. When the lower non-magnetic layer 3 contains a lubricant, the lubricant is oozed out from the lower non-magnetic layer 3 and moves into the upper magnetic layer 4 and further into the lubricant layer 5 on the upper magnetic layer 4. Accordingly, when the lower non-magnetic layer 3 contains a lubricant, it is possible to maintain the lubricant layer 5 for a long period of time and improve the running durability for a long period of time.

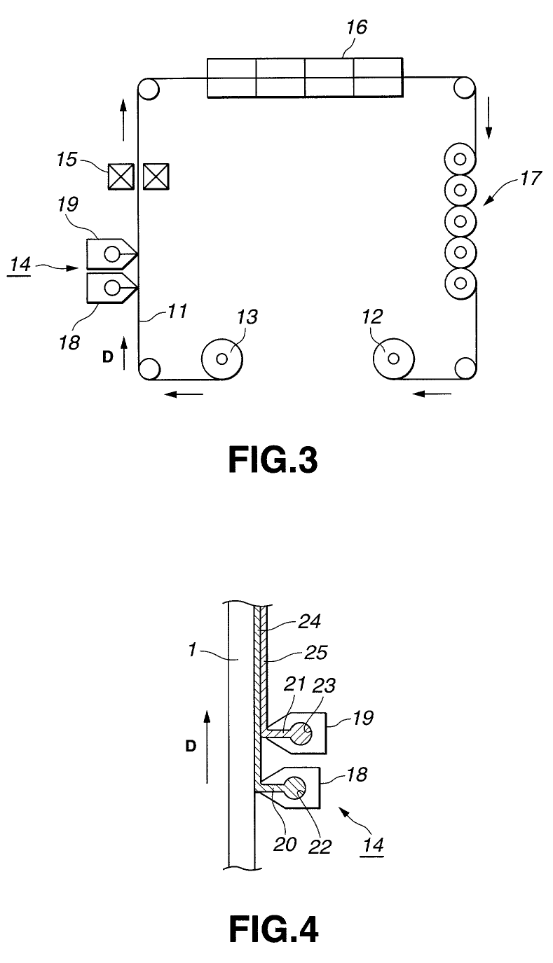

When producing the magnetic disc 1, it is preferable to form the lower non-magnetic layer 3 and the upper magnetic layer 4 by the so-called wet-on-wet method. More specifically, when forming the lower non-magnetic layer 3 and the upper magnetic layer 4 on the non-magnetic support body 2 by the wet-on-wet method, for example, it is possible to use a paint film forming apparatus 10 as shown in FIG. 3. After forming the lower non-magnetic layer 3 and the upper magnetic layer 4 on the belt-shaped non-magnetic support body 2 using the paint film forming apparatus 10, the layered material is punched into a disc shape to obtain the magnetic disc 1.

The paint film forming apparatus 10 includes a takeup roll 12 for taking up the belt-shaped non-magnetic support body 2 and a supply roll 13 from which the non-magnetic support body 2 is supplied, a coating unit 14 for applying a non-magnetic paint and a magnetic paint onto the non-magnetic support body 2 pulled out from the supply roll 13, an orientation magnet 15 for determining the magnetization direction of the magnetic layer, a drying unit 16 for drying the paints, and a calendar unit 17 for performing a calendar processing.

That is, in this paint film forming apparatus 10, the non-magnetic support body 2 is conveyed from the supply roll 13 to the takeup roll 12 and along this convey route, the coating unit 14, the orientation magnet 15, the drying unit 16, and the calendar unit 17 are arranged in this order.

In this paint film forming apparatus 10, firstly, the coating unit 14 applies a non-magnetic paint and a magnetic paint in a double layer onto the non-magnetic support body 2. As shown in FIG. 4, this coating unit 14 includes a first extrusion coater 18 for applying the non-magnetic paint and a second extrusion coater 19 for applying the magnetic paint. Moreover, in this coating unit 14, the second extrusion coater 19 is arranged at the send-out side of the non-magnetic support body 2 and the first extrusion coater 18 is arranged at the introduction side of the non-magnetic support body 2.

The first extrusion coater 18 and the second extrusion coater 19 have slit portions 20 and 21, respectively, at their ends. Behind the slid portions 20 and 21 are arranged paint ports 22 and 23 are arranged supplied with the paints. In the first extrusion coater 18 and the second extrusion coater 19, the non-magnetic paint and the magnetic paint supplied to the ports 22 and 23 are extruded to the coater ends through the slit portions 20 and 21, respectively.

The non-magnetic support body 2 onto which the paints are to be applied travels in the direction indicated by the arrow D in FIG. 4 along the end faces of the first extrusion coater 18 and the second extrusion coater 19.

On the non-magnetic support body 2 thus conveyed, firstly, when it passes by the first extrusion coater 18, the non-magnetic paint extruded from the slit portion 20 is applied to form a non-magnetic paint film 24. When the non-magnetic support body 2 passes by the second extrusion coater 19, the magnetic paint extruded from the slit portion 21 is applied onto the non-magnetic paint film 24 which is in a wet state, so as to form a magnetic paint film 25.

It should be noted that the paint supply to the first extrusion coater 18 and to the second extrusion coater 19 may be performed via an in-line mixer.

Thus, the non-magnetic paint film 24 and the magnetic paint film 25 are formed on the non-magnetic support body 2, which is conveyed to the orientation magnet 15, the drying unit 16, and the calendar unit 17.

At the orientation magnet 15, the magnetic paint film 25 to serve as the magnetic layer is subjected to a magnetic field orientation processing. It should be noted that as the orientation magnet 15, a magnet for random orientation is used. The orientation magnet 15 may be selected according to the type of the magnetic powder contained in the magnetic layer 3.

In the drying unit 16, the non-magnetic paint film 24 and the magnetic paint film 25 are dried by hot blow from the nozzles arranged at the top and the bottom of the drying unit 16. The drying condition is preferably as follows: the temperature is at 30° C. to 120° C. and the drying time is about 0.1 minutes to 10 minutes.

The non-magnetic support body 2 which has passed through the drying unit 16 advances to the calendar unit 17 so as to be subjected to a surface flattening processing. In this surface flattening processing performed by the calendar unit 17, the temperature, the linear pressure, and the convey speed are the most important factors. That is, the surface flattening processing is preferably performed under the condition as follows: the temperature is at 50° C. to 140° C., the linear pressure is 50 kg/cm² to 1000 kg/cm², and the convey speed is 20 m/minute to 1000 m/minute. Unless these conditions are satisfied, the surface characteristic of the upper magnetic layer 4 may be deteriorated.

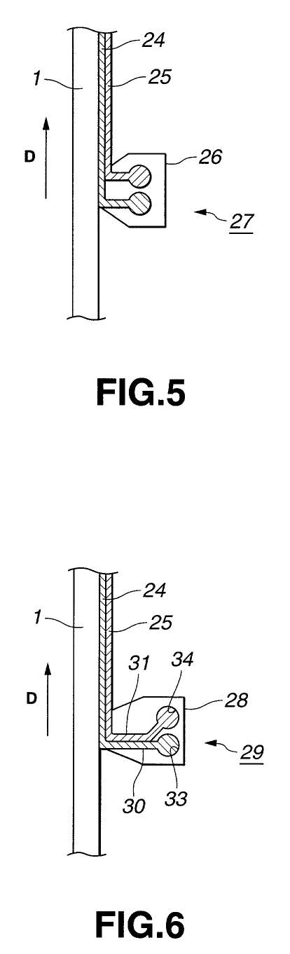

It should be noted that in this paint film forming apparatus 10, the non-magnetic paint and the magnetic paint are applied by the separate coaters. However, the present invention is not to be limited to such a coating unit 14. That is, as shown in FIG. 5, the first extrusion coater 18 and the second extrusion coater 19 may be formed as a unitary block of an extrusion coater 26 provided as a coating unit 27.

Moreover, in the aforementioned paint film forming apparatus 10, the non-magnetic paint and the magnetic paint are successively applied by the coating unit 14 and 27. However, the present invention is not to be limited to this. The coating unit may simultaneously apply the non-magnetic paint and the magnetic paint. That is, as shown in FIG. 6, it is possible to use a coating unit 29 including an extrusion coater 28 in which two slits are formed in proximity to each other so that the non-magnetic paint and the magnetic paint are simultaneously applied by this extrusion coater 28.

In this coating unit 29, a first slit portion 30 and a second slit portion 31 are formed in proximity to each other through which a paint is extruded to the tip portion of the extrusion coater 28. Behind the two slit portions 30 and 31 are arranged a first paint port 33 for supplying a non-magnetic paint and a second paint port 34 for supplying a magnetic paint.

In this coating unit 29, the non-magnetic paint supplied to the first paint port 33 is applied through the first slit portion 30 onto the non-magnetic support body 2 to form the non-magnetic paint film 24; and almost simultaneously with this, the magnetic paint supplied to the second paint port 34 is applied through the second slit portion 31 onto the non-magnetic paint film 24 in a wet state to form the magnetic paint films 25.

Moreover, in the aforementioned coating units 14, 27, 29, the extrusion coater may be replaced by berth roll, gravure roll, air doctor coater, blade coater, air knife coater, squeeze coater, impregnation coater, transfer roll coater, kiss coater, cast coater, spray coater, and the like. In this case, the application method of the non-magnetic paint and the application method of the magnetic paint may be same or different. Accordingly, it is also possible to apply the magnetic paint and the non-magnetic paint by using a combination of a reverse roll and an extrusion coater or a combination of a gravure roll and an extrusion coater.

It should be noted that in the magnetic disc 1, the lower non-magnetic layer 3 and the magnetic layer 4 should be formed on the both sides of the non-magnetic support body 2 by the aforementioned method. Moreover, after the lower non-magnetic layer 3 and the magnetic layer 4 are formed on the non-magnetic support body 2, the burnishing or blade processing is performed when necessary.

Lastly, the magnetic disc 1 is completed by punching into a disc shape with a predetermined diameter.

The magnetic disc 1 thus prepared is preferably used on a disc drive apparatus having rpm not less than 3000 rpm and the circumferential velocity not less than 1.6 m/s. Such a disc drive apparatus includes a pair of magnetic head units arranged so as to sandwich both main surfaces of the magnetic disc 1. The magnetic disc 1 is sandwiched by the pair of magnetic head units and rotated at a predetermined rotation speed. Here, the magnetic head unit may be an inductive head or a magneto-resistive head. Moreover, the magnetic head unit forms an air film between the head and the rotating magnetic disc 1 so that a signal is recorded/reproduced by the magnetic head flying at a distance not greater than 100 nm from the main surface of the magnetic disc 1.

In the aforementioned magnetic disc 1, the lubricant layer 5 is arranged on the surface of the upper magnetic layer 4. This enables to obtain an excellent running durability on the disc drive apparatus using the flying-type magnetic head unit. That is, even when the flying-type magnetic head unit collides onto the magnetic disc 1, the lubricant layer 5 protects the upper magnetic layer 4 from damage. In other words, the magnetic disc 1 having the lubricant layer 5 has an excellent running durability.

Especially in the aforementioned magnetic disc 1, the lubricant amount existing on the surface of the upper magnetic layer 4 is defined by a value (A−B) wherein A is an area value of an absorption spectrum of a wavelength 2940 cm⁻¹ to 2800 cm⁻¹ when the surface of the upper magnetic layer 4 is measured by the attenuated total reflectance measurement method using the Fourier transform infrared spectroscopy and B is an area value of an absorption spectrum of a wavelength 2940 cm⁻¹ to 2800 cm⁻¹ when the surface of the upper magnetic layer 4 without the lubricant layer 5 is measured by the attenuated total reflectance measurement method using the Fourier transform infrared spectroscopy.

Thus, by defining the lubricant amount existing on the surface of the upper magnetic layer 4 using the attenuated total reflectance measuring method using the Fourier transform infrared spectroscopy, it is possible to accurately evaluate the lubricant amount on the surface of the upper magnetic layer 4. In the magnetic disc 1, this value (A−B) is defined not less than 0.01 and not greater than 0.30. When the value (A−B) is less than 0.01, the lubricant amount on the surface of the upper magnetic layer 4 is too small and it is impossible to obtain an excellent running durability. Moreover, when the value (A−B) exceeds 0.30, the lubricant amount on the surface of the upper magnetic layer 4 is too large and the distance between the flying-type magnetic head unit and the upper magnetic layer 4 becomes too large, causing a spacing loss and deteriorating the electro-magnetic conversion characteristic.

For this, by defining the value (A−B) in a range not less than 0.01 and not greater than 0.30, it is possible to accurately define a desired amount of the lubricant existing on the surface of the upper magnetic layer 4, enabling simultaneously obtain an excellent running durability and an excellent electro-magnetic conversion characteristic.

### EXAMPLES

Hereinafter, specific examples of the present invention will be detailed. However, the present invention is not to be limited to these examples.

### Example 1

In Example 1, we prepared as a sample a magnetic disc including a non-magnetic support body having a lower non-magnetic layer and an upper magnetic layer formed on the lower non-magnetic layer. Firstly, we prepared a magnetic paint to form the upper magnetic layer and a non-magnetic paint to form the lower non-magnetic layer. The non-magnetic paint and the magnetic paint had compositions as shown below and were kneaded and dispersed using a kneader and a sand mill, respectively.

| <Magnetic paint composition> | | |
|---|---|---|
| ferromagnetic powder: | | |
| Fe-system metal ferromagnetic powder | 100 | weight parts |
| (specific surface 51 m²/g, coercive force 1600 Oe) | | |
| polyurethane resin containing sulfonic acid sodium | 4 | weight parts |
| group | | |
| vinyl chloride resin containing sulfonic acid | 16 | weight parts |
| potassium group | | |
| carbon black (#50, trade name produced by | 4 | weight parts |
| Asahi Carbon Co., Ltd.) | | |
| α- alumina | 8 | weight parts |
| heptyl stearate (lubricant) | 2.0 | weight parts |
| oleyl oleate (lubricant) | 1.0 | weight part |
| methylethyl ketone | 200 | weight parts |
| toluene | 150 | weight parts |
| cyclohexane | 200 | weight parts |
| <non-magnetic paint> | | |
| α-Fe₂O₃ (specific surface 52 m²/g) | 100 | weight parts |
| polyurethane resin containing sulfonic acid sodium | 4 | weight parts |
| group | | |
| vinyl chloride resin containing sulfonic acid | 16 | weight parts |
| potassium group | | |
| heptyl stearate (lubricant) | 2.0 | weight parts |
| oleyl oleate (lubricant) | 1.0 | weight part |
| methylethyl ketone | 100 | weight parts |
| toluene | 50 | weight parts |
| cyclohexane | 100 | weight parts |

The magnetic paint and the non-magnetic paint thus prepared were applied by the wet-on-wet method onto a main surface of a non-magnetic support body made from polyethylene terephthalate having a thickness of 60 μm. After this, the random magnetization processing and the drying processing were successively performed. Then, the magnetic paint and the non-magnetic paint were applied onto the other surface of the non-magnetic support body by the wet-on-wet method. After this, similarly, the random magnetization processing and the drying processing were successively performed. After this, calendar processing was performed at temperature of 60° C. Then the non-magnetic support body having the magnetic layer and the non-magnetic layer on its both surfaces was punched into a disc shape of 3.5 inches, which was left in an oven at 60° C. for 20 hours to be subjected to the curing processing to complete a magnetic disc. It should be noted that this magnetic disc had the lower non-magnetic layer having a thickness of 1.5 μm and the upper magnetic layer having a thickness of 0.5 μm.

### Example 2

In Example 2, a magnetic disc was prepared in the same way as Example 1 except for that only 0.5 weight parts of heptyl stearate was added as the lubricant in the magnetic paint; and 1.0 weight part of heptyl stearate and 1.0 weight part of oleyl oleate were added as the lubricant in the non-magnetic paint.

### Example 3

In Example 3, a magnetic disc was prepared in the same way as Example 1 except for that 3.0 weight parts of heptyl stearate and 2.0 weight parts of oleyl oleate were added as the lubricant in the magnetic paint; and 5.0 weight parts of heptyl stearate and 5.0 weight parts of oleyl oleate were added as the lubricant in the non-magnetic paint.

### Example 4

In Example 4, a magnetic disc was prepared in the same way as Example 1 except for that 5.0 weight parts of heptyl stearate and 5.0 weight parts of oleyl oleate were added as the lubricant in the magnetic paint; and 5.0 weight parts of heptyl stearate and 5.0 weight parts of oleyl oleate were added as the lubricant in the non-magnetic paint.

### Comparative Example 1

In Comparative Example 1, a magnetic disc was prepared in the same way as Example 1 except for that only 1.0 weight part of heptyl stearate was added as the lubricant in the magnetic paint; and only 1.0 weight part of heptyl stearate was added as the lubricant in the non-magnetic paint.

### Comparative Example 2

In Comparative Example 2, a magnetic disc was prepared in the same way as Example 1 except for that no lubricant was added to the magnetic paint; and 1.0 weight part of heptyl stearate and 1.0 weight part of oleyl oleate were added as the lubricant in the non-magnetic paint.

### Comparative Example 3

In Comparative Example 3, a magnetic disc was prepared in the same way as Example 1 except for that 6.0 weight parts of heptyl stearate were added as the lubricant in the magnetic paint; and 6.0 weight parts of heptyl stearate and 6.0 weight parts of oleyl oleate were added as the lubricant in the non-magnetic paint.

<Evaluation of Characteristics>

By using the Examples 1 to 4 and Comparative Examples 1 to 3 thus prepared, the surface lubricant amount, the electro-magnetic conversion characteristic, and the running durability were evaluated.

[Measurement of the Surface Lubricant Amount]

For the surface lubricant amount, the attenuated total reflectance measurement (hereinafter, referred to as the ATR measurement) was performed by mounting an attachment for the attenuated total reflectance (ATR) produced by Harrick Co., Ltd. on the FT-IR apparatus (trade name: Magna 550) produced by Nicolet Co., Ltd. The measurement condition was set as follows: infrared light incident angle 75 degrees; the number of times data processing is integrated 256; the infrared light beam diameter 5 mm; and the ATR crystal was Ge crystal.

More specifically, the magnetic disc to be measured was subjected to the ATR measurement under the aforementioned conditions. After this, the magnetic disc was washed by hexane for 2 hours and then again subjected to the ATR measurement. In the ATR measurement, the spectrum data obtained was used to calculate an absorption spectrum area value in the wavelength area of 2940 cm⁻¹ to 2800 cm⁻¹. Then, a difference between the area value of the magnetic disc before the washing and the area value of the magnetic disc after the washing was calculated to serve as the surface lubricant amount.

[Evaluation of the Electro-Magnetic Conversion Characteristic]

The electro-magnetic characteristic was evaluated by using a spin stand of 3600 rpm to measure an output of an outer circumference in the recording frequency of 25 MHZ for the portion at about 40 mm from the center of the magnetic disc to be evaluated. More specifically, measurement was performed five times to obtain an average output value as the electro-magnetic conversion characteristic. It should be noted that Examples 2 to 4 and Comparative Examples 1 to 3 were evaluated based on the value of Example 1.

[Evaluation of the Running Durability]

For the running durability, a data written over 300 tracks at the outer circumference at 3600 rpm under the environment of 45° C. and 30% rh was repeatedly reproduced and evaluation was made as a time when an uncorrectable error occurred. It should be noted that the error measurement time was set to 200 hours at maximum.

<Results>

Table 1 below shows the evaluation results of the surface lubricant amount measurement, the electro-magnetic conversion characteristic, and the running durability.

TABLE 1

| | Lubricant added | | | | Running |
|---|---|---|---|---|---|
| | (total amount) | | | | durability |
| | upper | lower | ATR | Output ratio | (error |
| | magnetic | non-magnetic | area | (compared to | occur- |
| | layer | layer | value | Example 1) | rence) |
| Example 1 | 3 | 3 | 0.012 | 100% | >200 hrs |
| | weight | weight | | | |
| | parts | parts | | | |
| Example 2 | 0.5 | 2 | 0.049 | 110% | >200 hrs |
| | weight | weight | | | |
| | parts | parts | | | |
| Example 3 | 5 | 10 | 0.152 | 93% | >200 hrs |
| | weight | weight | | | |
| | parts | parts | | | |
| Example 4 | 10 | 10 | 0.3 | 91% | >200 hrs |
| | weight | weight | | | |
| | parts | parts | | | |
| Compara- | 0.1 | 1 | 0.002 | 125% | 25 hrs |
| tive | weight | weight | | | |
| Example 1 | parts | part | | | |
| Compara- | 0 | 2 | 0.006 | 112% | 135 hrs |
| tive | weight | weight | | | |
| Example 2 | part | parts | | | |
| Compara- | 12 | 12 | 0.408 | 75% | 155 hrs |
| itve | weight | weight | | | |
| Example 3 | parts | parts | | | |

As is clear from Table 1, in Examples 1 to 4 in which the area value as the ATR area value difference between before and after the washing is in a range not less than 0.01 and not greater than 0.30, both of the electro-magnetic conversion characteristic and the running durability are excellent. As compared to this, in Comparative Examples 1 to 3 in which the area value is out of the range not less than 0.01 and not greater than 0.30, the electro-magnetic characteristic and the running durability are not preferable. Especially in comparative Examples 1 and 2 in which the area value is less than 0.01, the lubricant amount is too small and a sufficient running durability cannot be obtained although the electro-magnetic conversion characteristic is preferable. On the contrary, in Comparative Example 3 in which the area value exceeds 0.30, the lubricant amount is too great and a sufficient electro-magnetic characteristic cannot be obtained. Moreover, in Comparative Example 3, the running durability measurement test caused a plenty of scars on the surface and it was impossible to obtain a preferable running durability. The reason is considered to be that too much lubricant plasticizes the upper magnetic layer.

The aforementioned experiment results show that in the magnetic disc having the area value as the ATR area value difference before and after washing in the range not less than 0.01 and not greater than 0.30, the upper magnetic layer surface can have an excellent lubrication effect and it is possible to prevent plasticization of the upper magnetic layer, enabling to obtain both of the excellent electro-magnetization characteristic and the excellent running durability.

As has been described above, in the magnetic recording medium according to the present invention, the lubricant amount existing on the magnetic layer surface is defined as (A−B) in a range not smaller than 0.01 and not greater than 0.30 wherein A is the area value before washing B is the area value after washing, the values being measured for the absorption spectrum having a wavelength of 2940 cm⁻¹ to 2800 cm⁻¹ by the attenuated total reflectance measurement method using the Fourier transform infrared spectroscopy. Accordingly, in this magnetic recording medium, the lubricant amount on the magnetic layer surface can be accurately evaluated and it is possible to simultaneously obtain the excellent electro-magnetic characteristic and the excellent running durability.

What is claimed is:

1. A magnetic recording medium including a non-magnetic support body having a magnetic layer formed by applying a magnetic paint prepared by kneading at least a binder and a magnetic powder and a lubricant layer formed on the magnetic layer surface,
wherein a value (A−B) is in a range not less than 0.01 and not greater than 0.30 wherein A is an area value of an absorption spectrum of a wavelength 2940 cm⁻¹ to 2800 cm⁻¹ when the magnetic layer surface is measured by the attenuated total reflectance measurement method using the Fourier transform infrared spectroscopy and B is an area value of an absorption spectrum of a wavelength 2940 cm⁻¹ to 2800 cm⁻¹ when the magnetic layer surface without the lubricant layer is measured by the attenuated total reflectance measurement method using the Fourier transform infrared spectroscopy.

2. The magnetic recording medium as claimed in claim 1, wherein the magnetic layer is formed by applying the magnetic paint onto a non-magnetic layer formed by applying a non-magnetic paint prepared by kneading at least a binder and a non-magnetic powder while the non-magnetic layer is not dried.
